(19) United States
(12) Patent Application Publication
(10) Pub. No.: US 2008/0020808 A1
(43) Pub. Date: Jan. 24, 2008

(54) METHOD AND SYSTEM TO SUPPORT FAST CONNECTION SET-UP IN COMMUNICATION NETWORKS

(75) Inventors: Huai Y. Wang, Coconut Creek, FL (US); Floyd D. Simpson, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/459,465

(22) Filed: Jul. 24, 2006

(51) Int. Cl. H04M 1/00

(52) U.S. Cl. 455/574

(57) ABSTRACT

A method (200) and system (100) for supporting fast connection set-up in a communication network (110). The method can include the steps of - in a mobile station (114) that is capable of operating in at least two separate power saving modes, a first power saving mode and a second power saving mode, entering (212) an operational state associated with the second power saving mode and staying (214) in the first power saving mode. This process can enable the mobile station to avoid entry into the second power saving mode during the operational state. In the first power saving mode, the mobile station may remain registered with a communication network. In the second power saving mode, the mobile station may be de-registered from the communication network. The first power saving mode can be a sleep mode, and the second power saving mode can be an idle mode.

### BACKGROUND OF THE INVENTION

1. Field of the Invention

The present invention concerns the improvement of communication systems and more particularly, the reduction in connection set-up for communication devices in such systems.

2. Description of the Related Art

Under the 802.16e standard, there are two modes of operation that are suitable for conserving power at mobile stations: (1) a sleep mode; and (2) an idle mode. In sleep mode, the mobile station (MS) conducts pre-negotiated periods of absence from the serving base station (BS) air interface. The MS, however, remains registered with the serving BS during sleep mode. As such, active applications may continue to run on the MS during this mode of operation.

In idle mode, the MS periodically makes itself available for receiving downlink broadcast messages that indicate pending traffic for the MS, but the MS is not registered with the BS during this mode. By de-registering from the BS, the MS is no longer required to perform handover procedures between BSs. As a result, an MS typically moves to an idle mode when the MS has no application running for a certain amount of time. Because the MS is de-registered from the BS in idle mode, however, the MS must re-register with the network if the MS determines that traffic intended for it is pending at the network. This re-registration process can add a significant amount of time to the connection set-up of the relevant MS application. In fact, the problem is exacerbated if the application involves another MS in idle mode because the re-registration of the other MS also adds to the delay.

### SUMMARY OF THE INVENTION

The present invention concerns a method for supporting fast connection set-up in a communication network in an MS that is capable of operating in at least two separate power saving modes - a first power saving mode and a second power saving mode. The method can include the steps of entering an operational state associated with the second power saving mode and staying in the first power saving mode. This process avoids entry into the second power saving mode during the operational state. In the first power saving mode, the MS may remain registered with a communication network, and in the second power saving mode, the mobile station may be de-registered from the communication network.

As an example, the first power saving mode can be a sleep mode, and the second power saving mode can be an idle mode. As another example, the operational state can be a state where no application is currently running on the MS, and the communication network can be an 802.16e network. In one arrangement, staying in the first power saving mode can be based on predefined criteria. For example, the predefined criteria include a type of subscription for the MS, a time of day, a geographic location or the second power saving mode being incompatible with an application's demand property of the MS.

The present invention also concerns an MS that operates in a communication network and optionally in at least two separate power saving modes, a first power saving mode and a second power saving mode. The MS can include a user interface for enabling operation of at least one application and a processor coupled to the user interface. The processor can be programmed to cause the MS to enter an operational state associated with the second power saving mode and to cause the MS to stay in the first power saving mode. As noted above, this process may avoid entry into the second power saving mode during the operational state. The MS can include suitable software and circuitry for carrying out any of the steps described above.

The present invention also concerns a machine readable storage, having stored thereon a computer program having a plurality of code sections executable by an MS that is capable of operating in at least two separate power saving modes—a first power saving mode and a second power saving mode. The program can cause the MS to support fast connection set-up in a communication network by entering an operational state associated with the second power saving mode and staying in the first power saving mode, thereby avoiding entry into the second power saving mode during the operational state. The program can include further code sections for causing the MS to carry out any of the steps described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for supporting fast connection set-up in communication networks in accordance with an embodiment of the inventive arrangements; and

FIG. 2 illustrates a method for supporting fast connection set-up in communication networks in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein. The term “transceiver” can include any component that is capable of receiving and/or transmitting wireless signals.

The present invention concerns a method and system for supporting fast connection set-up in a communication network. The method can include the steps of—in a mobile station that is capable of operating in at least two separate power saving modes, a first power saving mode and a second power saving mode, entering an operational state associated with the second power saving mode and staying in the first power saving mode. Such a process can enable the mobile station to avoid entry into the second power saving mode during the operational state.

In the first power saving mode, the mobile station may remain registered with a communication network. Additionally, in the second power saving mode, the mobile station may be de-registered from the communication network. As an example, the first power saving mode can be a sleep mode, and the second power saving mode can be an idle mode. By maintaining the mobile station in the sleep mode, the mobile station can have faster connection set-up for applications that it runs. For example, the initial set-up time for a push-to-talk call can be reduced in this arrangement.

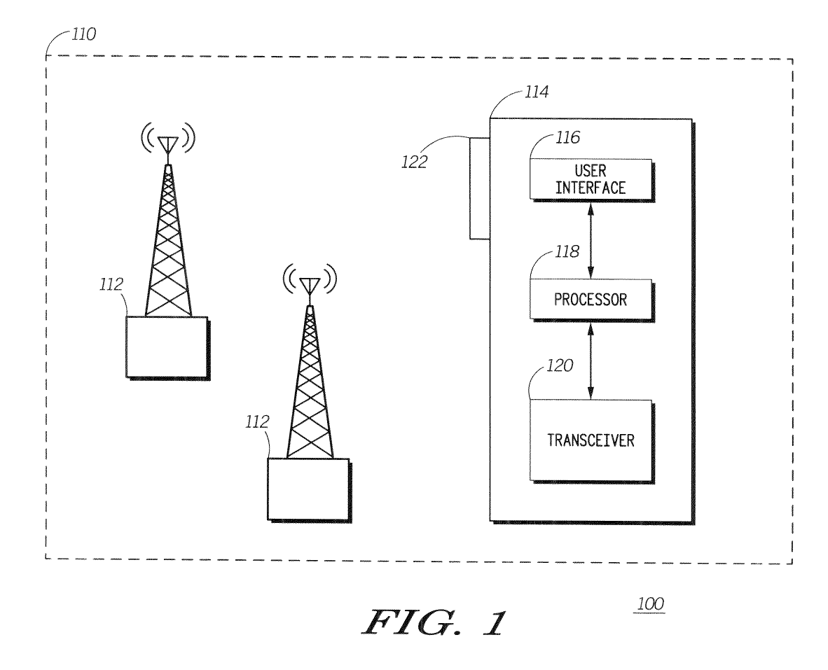

Referring to FIG. 1, a system 100 for supporting fast connection set-up in a communication network 110 is shown. The network 110 may include one or more base stations (BS) 112, which may wirelessly communicate with one or more mobile stations (MS) 1 14. As an example, the network 110 may operate in accordance with the 802.16e standard promulgated by the Institute of Electronics and Electrical Engineers (IEEE), which may also be referred to as WiMax it is understood, however, that the invention is not so limited, as the network 110 can operate in accordance with any other suitable standard or protocol.

In one arrangement, the MS 114 may include a user interface 116, a processor 118 and a transceiver 120. Additionally, the processor 118 may be coupled to and control the operation of the user interface 116 and the transceiver 120. Through the transceiver 120, the MS 114 is able to exchange voice and/or data with the network 110. A user may enter information into and receive information from the MS 114, such as data and/or voice, through the user interface 116. The MS 114 can be designed to support various applications. In one particular embodiment, the MS 114 can support dispatch or push-to-talk communications. To do so, the MS 114 can include a PTT button 122, which may be part of the user interface 116.

As is known in the art, it is desirable to have fast connection set-up in PTT communications. In fact, there is an effort in the industry to reduce PTT connection set-up time to around or even below 600 milliseconds (ms). A connection set-up or connection set-up time in the PTT context can be the time that it takes for the network 110 to establish the proper signaling connections with the MS 114 to enable a user to transmit or receive voice or data to or from the network 110. It is understood, however, that a PTT application is not the only application that the MS 114 may support, or for that matter, the only application for which the MS 114 seeks to reduce a connection set-up time.

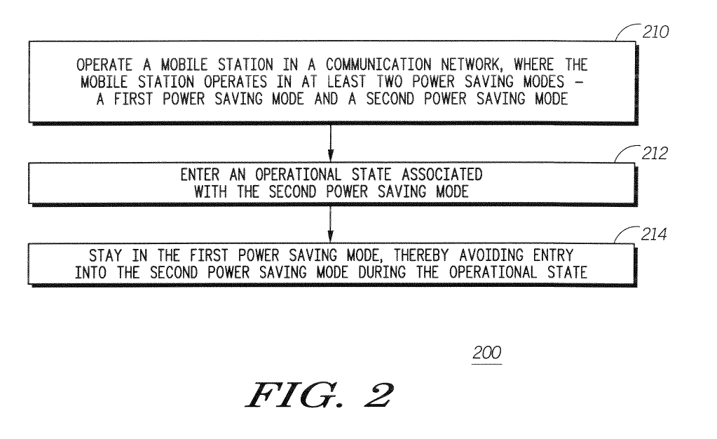

Referring to FIG. 2, a method 200 for supporting fast connection set-up in a communication network is shown. When describing the method 200, reference will be made to FIG. 1, although it is understood that the method 200 can be practiced in any other suitable system or device and in accordance with any suitable protocol(s). Moreover, the steps of the method 200 are not limited to the particular order in which they are presented in FIG. 2. The inventive method can also have a greater number of steps or a fewer number of steps than those shown in FIG. 2.

At step 210, a mobile station in a communication network can be operated, where the mobile station may operate in at least two power saving modes—a first power saving mode and a second power saving mode. At step 212, the mobile station can enter an operational state associated with the second power saving mode. The mobile station may stay in the first power saving mode, thereby avoiding entry into the second power saving mode during the operational state, as shown at step 214.

For example, referring to FIG. 1, the communication network 110 may be an 802.16e network, and the MS 114 can operate in this network 110. As such, to save battery life, the MS 114 may operate in at least two power saving modes. A power saving mode can be any mode in which certain portions of the MS 114 are temporarily shut down to conserve energy. As an example, the first power saving mode can be a sleep mode, and the second power saving mode can be an idle mode. In a sleep mode, the MS 114 can remain registered with the network 110, which means that the MS 114 may at least maintain its signaling connections with the network 110. In contrast, in the idle mode, the MS 114 can de-register from the network 110, which means that no signaling connections with the network 110 are in place. As is known in the art, in the sleep mode, handover procedures continue to take place, while in idle mode, handover procedures no longer occur.

To enter the sleep mode or the idle mode, the MS 114 signals the relevant BS 112 of the network 110, and the MS 114 and the BS 112 follow standard procedures to carry out the particular request. As is also known in the art, the MS 114 may enter a sleep mode when the MS 114 is running an application, such as a PTT call. During the sleep mode, certain portions of the MS 114, like the receiver or transmitter portion of the transceiver 120, may be temporarily shut down to preserve battery life. If the MS 114 is not currently running an application, the MS 114 may enter the idle mode and de-register from the network 110 to prolong the charge on the battery. This transition to the idle mode may also depend on whether the MS 114 is presently moving, as little or no movement of the MS 114 would favor entering the idle mode.

The MS 114 may eventually enter an operational state associated with the second power saving mode, e.g., the idle mode. The term “operational state associated with the second power saving mode” may refer to any condition of the MS 114 that would typically cause the MS 114 to enter the second power saving mode. For example, the MS 114 may not be currently running an application and may be stationary or moving very little.

In one arrangement, the processor 118 may be programmed to keep the MS 114 in the first power saving mode, which, in this example, is the sleep mode, during the operational state. Maintaining the MS 114 in the sleep mode can be performed instead of causing the MS 114 to enter the idle mode. As such, the MS 114 can maintain its signaling connections with the network 110 and can remain registered with the network 110.

Thus, because it may remain registered with the network 110, the MS 114 can reduce the connection set-up time associated with one or more applications that it may run. For example, the initial set-up time for a PTT call, whether the MS 114 is the originating device or the called device, may be decreased, as the MS 114 does not have to go through the process of re-registering with the network 110. In addition, because the BS 112 does not reserve bandwidth for the signaling connections in sleep mode, there is no overall effect on the ability of the network 110 to transmit data to the MSs 114. Moreover, if the network 110 is, for example, an 802.16e network, the BS 112 can easily maintain connection identifications (CID) for the signaling connections, as the BS 112 can store a significant number of these CDs. Implementation of this process into the system 100 does not require any protocol changes, either.

While improving connection set-up for applications on the MS 114, keeping the MS 114 in the sleep mode may consume resources of the network 110 because the MS 114 remains registered with the BS 112. Also, the MS 114 may continue to perform handover while it is in sleep mode. Accordingly, it may be desirable to base the process of maintaining the MS 114 in the first power saving mode during the operational state on predefined criteria. As an example, the predefined criteria may be a type of subscription for the MS 114, a time of day, a geographic location or the second power saving mode being incompatible with an application of the MS 114.

In particular, a wireless carrier may charge a premium to allow a user of the MS 114 to subscribe to the feature described above. Also, the process of maintaining the MS 114 in the first power saving mode may only be performed during a certain time of day, such as during business hours when certain applications are more likely to be running on the MS 114. The MS 114 being in a particular geographic location, such as a workplace, may also trigger this feature.

As is known in the art, in the idle mode, the MS 114 may subscribe to a particular paging cycle set by the BS 112. In some cases, a paging cycle may be too long (temporally) for suitable operation of an application. For example, a long paging cycle may be ill-suited for setting up PTT calls, because it increases the initial set-up time. In this scenario, the process of keeping the MS 114 in the first power saving mode may be executed to avoid the lengthy paging cycle.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for supporting fast connection set-up in a communication network, comprising:
in a mobile station that is capable of operating in at least two separate power saving modes—a first power saving mode and a second power saving mode—entering an operational state associated with the second power saving mode; and
staying in the first power saving mode, thereby avoiding entry into the second power saving mode during the operational state, wherein in the first power saving mode, the mobile station remains registered with a communication network and in the second power saving mode, the mobile station is de-registered from the communication network.

2. The method according to claim 1, wherein the first power saving mode is a sleep mode and the second power saving mode is an idle mode.

3. The method according to claim 1, wherein the operational state comprises a state where no application is currently running on the mobile station.

4. The method according to claim 1, wherein the communication network is an 802.16e network.

5. The method according to claim 1, wherein staying in the first power saving mode further comprises staying in the first power saving mode based on predefined criteria.

6. The method according to claim 1, wherein the predefined criteria include a type of subscription for the mobile station, a time of day or the second power saving mode being incompatible with an application of the mobile station.

7. A mobile station that is capable of operating in a communication network and in at least two separate power saving modes, a first power saving mode and a second power saving mode, comprising:
a user interface for enabling operation of at least one application; and
a processor coupled to the user interface, wherein the processor is programmed to:
cause the mobile station to enter an operational state associated with the second power saving mode; and
cause the mobile station to stay in the first power saving mode, thereby avoiding entry into the second power saving mode during the operational state, wherein in the first power saving mode, the mobile station remains registered with a communication network and in the second power saving mode, the mobile station is de-registered from the communication network.

8. The mobile station according to claim 7 wherein the first power saving mode is a sleep mode and the second power saving mode is an idle mode.

9. The mobile station according to claim 7 wherein the operational state comprises a state where no application is currently running on the mobile station.

10. The mobile station according to claim 7 wherein the communication network is an 802.16e network.

11. The mobile station according to claim 7, wherein the processor is further programmed to cause the mobile station to stay in the first power saving mode based on predefined criteria.

12. The mobile station according to claim 11, wherein the predefined criteria include a type of subscription for the mobile station, a time of day or the second power saving mode being incompatible with an application of the mobile station.

13. A machine readable storage, having stored thereon a computer program having a plurality of code sections executable by a mobile station that is capable of operating in at least two separate power saving modes—a first power saving mode and a second power saving mode—for causing the mobile station to support fast connection set-up in a communication network by:
entering an operational state associated with the second power saving mode; and
staying in the first power saving mode, thereby avoiding entry into the second power saving mode during the operational state, wherein in the first power saving mode, the mobile station remains registered with a communication network and in the second power saving mode, the mobile station is de-registered from the communication network.

14. The machine readable storage according to claim 13, wherein the first power saving mode is a sleep mode and the second power saving mode is an idle mode.

15. The machine readable storage according to claim 13, wherein the operational state comprises a state where no application is currently running on the mobile station.

16. The machine readable storage according to claim 13, wherein the communication network is an 802.16e network.

17. The machine readable storage according to claim 13, wherein the computer program causes the mobile station to stay in the first power saving mode based on predefined criteria.

18. The machine readable storage according to claim 17, wherein the predefined criteria include a type of subscription for the mobile station a time of day or the second power saving mode being incompatible with an application of the mobile station.
